(19) United States
(12) Patent Application Publication
(10) Pub. No.: US 2012/0289205 A1
(43) Pub. Date: Nov. 15, 2012

(54) APPARATUS AND METHOD FOR ANONYMOUS CALLS TO AND FROM CELLULAR TELEPHONES

(76) Inventor: David Allen Burgess, Fairfield, CA (US)

(21) Appl. No.: 13/103,818

(22) Filed: May 9, 2011

(51) Int. Cl. H04W 4/00

(52) U.S. Cl. 455/414.1

(57) ABSTRACT

The invention is a system of modified cellular handsets and specially-programmed telephone exchanges operated so as to hide from telephone network operators the true identities of the parties to a telephone call. The invention includes features to hide the true identity of the user of a cellular telephone.

### FIELD OF THE INVENTION

The present invention pertains to the preservation of anonymity for the users for cellular telephones and for the remote parties with whom those users communicate.

### BACKGROUND OF THE INVENTION

There are so-called secure cellular phones in the market today, however these phones can actually pose an even greater security risk than ordinary phones, since the use of the specially secured signal can draw the attention of an intelligence service to a call that may otherwise have been ignored. The user of of such a secured telephone and anyone he/she contacts will automatically become intelligence targets. The resulting exposure of identity and calling information could be just as damaging to security as the actual content of the call. A better approach is to “blend into the crowd” and not give the intelligence service any reason to focus attention on a call or any reason to suspect that a specific cellular handset is of any intelligence value.

### SUMMARY OF THE INVENTION

An object of this invention is allow a cellular telephone user (“user”) to make and receive telephone calls while preventing the operator of the cellular network from determining the identity of the user.

It is a further object of this invention to prevent the operators of telephone networks from determining the identities of the remote parties with whom the user is communicating.

### DESCRIPTION OF PRIOR ART

### Brief Description of the Drawings

FIG. 1 shows the components of a system for placing calls from a remote originating party to a cellular telephone user while protecting the identities of both parties from a hostile PLMN operator.

FIG. 2 shows the steps of routing a telephone call using the system of FIG. 1.

FIG. 3 shows the components of a system to allow a user to place calls to a remote party while protecting the identity of both parties from a hostile PLMN operator.

FIG. 4 shows the steps of routing a telephone call using the system of FIG. 3.

FIG. 5 shows a modification of the system of FIG. 3 wherein the user communicates a destination number directly to the remote PBX through keypresses or speech recognition.

FIG. 6 shows the steps of routing a telephone call using the system of FIG. 5.

While the patent invention shall now be described with reference to the preferred embodiments shown in the drawings, it should be understood that the intention is not to limit the invention only to the particular embodiments shown but rather to cover all alterations, modifications and equivalent arrangements possible within the scope of appended claims.

The invention comprises two or more components: a modified cellular handset (“handset”) running special software to automatically modify its identity parameters and at least one remote private branch exchange (“PBX”) that has been specially programmed to obfuscate its call routing activities.

### DETAILED DESCRIPTION OF THE DRAWINGS

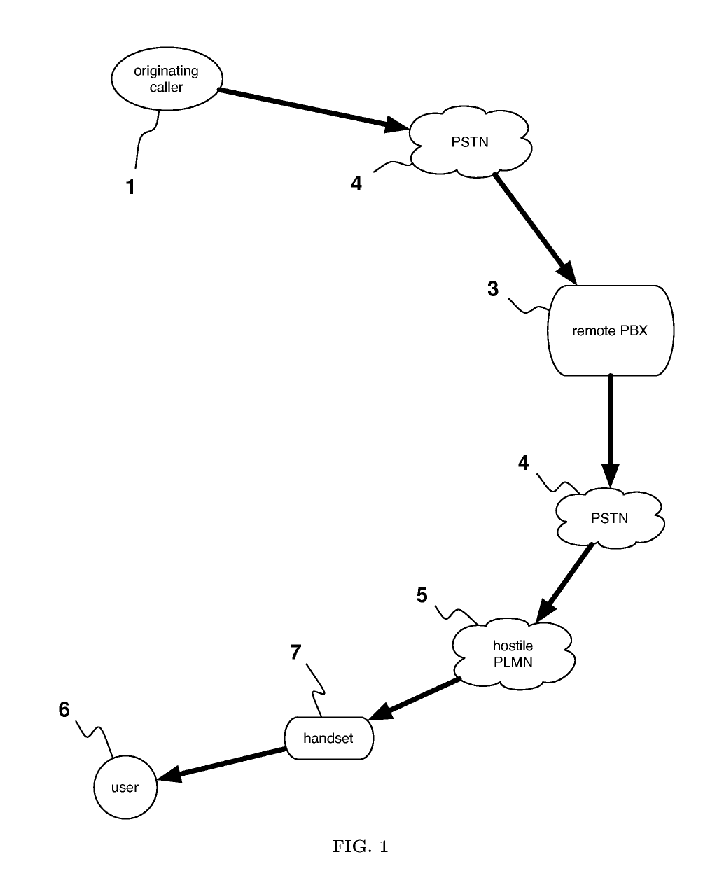

FIG. 1 shows the components of a system for placing anonymous calls from an originating party to a users of that system.
The “user” (6) is a person who wishes to receive and place cellular telephone calls without exposing his or her identify, or the identities or his or her associates, to the operators of the telephone networks user to carry the calls.
The “originating caller” (1) is a party remote who wishes to place a call to the user (6).
The “remote PBX” (3) is a telephone switching system or “private branch exchange” that is capable of automatically receiving and placing telephone calls and connecting audio paths between these calls.
The “PSTN” (4) is the public switched telephone network.
The “hostile PLMN” (5) is a public land mobile network operated by parties who are attempting to the user (6) and his or her associates.
The “handset” (7) is a cellular handset that has been modified to change its IMEI upon request or whenever the handset's SIM is changed. Heavy arrows in FIG. 1 show paths of communication.

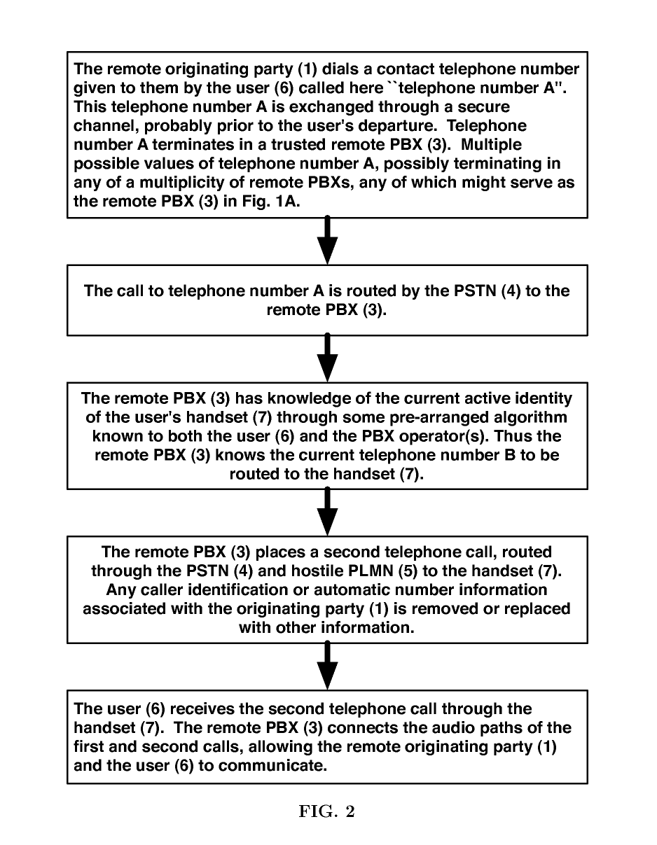

FIG. 2 shows the steps of routing of an inbound telephone call from a remote party to the user, through the system of FIG. 1, while protecting the identities of both parties. Numbers in this figure reference elements of FIG. 1.

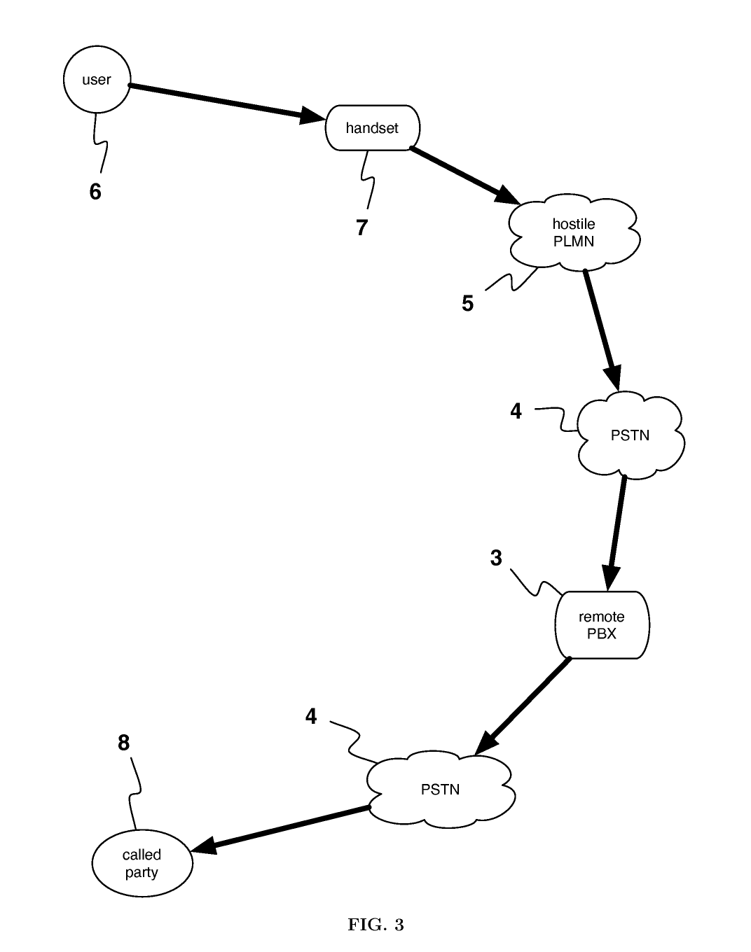

FIG. 3 shows the components of a system for placing anonymous calls from an originating party to a users of that system. Numbering of components is the same as in FIG. 1, with the addition of a “called party” (8) to who the user (6) wishes to place a telephone calls.

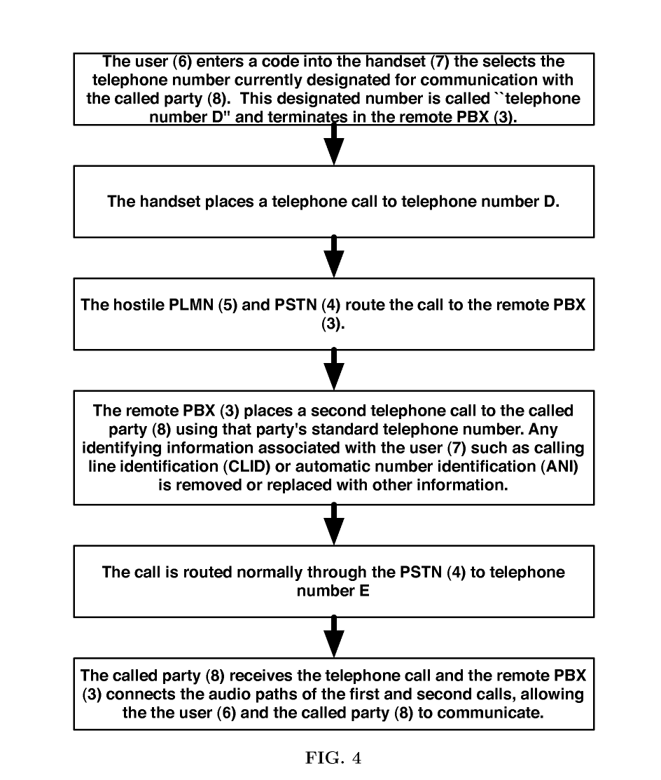

FIG. 4 shows shows the steps of routing of an outbound telephone call from the user to a remote party, through the system of FIG. 3, while protecting the identities of both parties. Numbers in this figure reference elements of FIG. 3.

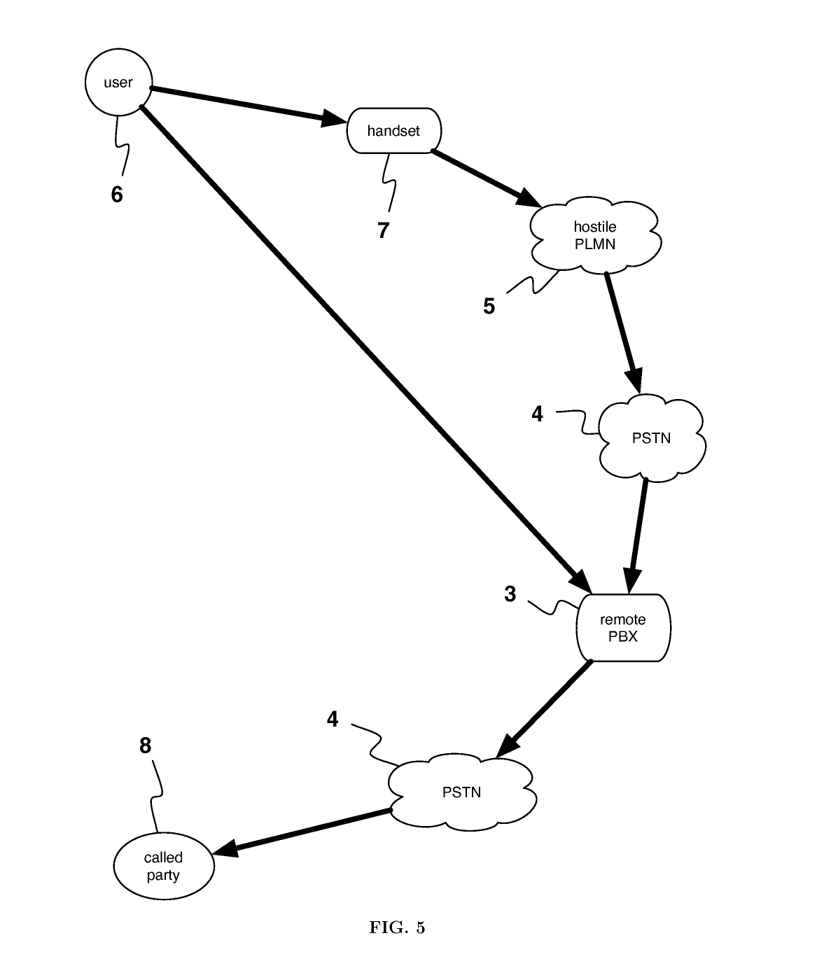

FIG. 5 shows the components of a system for placing anonymous calls from an originating party to a users of that system using a “dial-through” mechanism that allows the user to call phone numbers not originally programmed into the remote PBX. Numbering of components is the same as in FIG. 1.

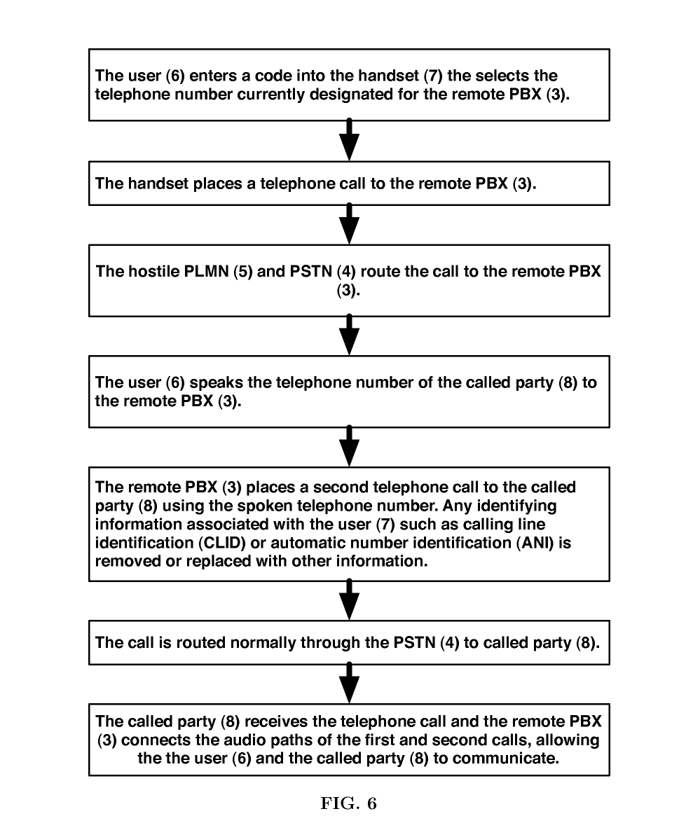

FIG. 6 shows shows the steps of routing of an outbound telephone call from the user to a remote party, through the system of FIG. 5, while protecting the identities of both parties. Numbers in this figure reference elements of FIG. 5.

### First Embodiment

In an initial embodiment, the invention is described in terms of the GSM cellular standard, although analogous techniques can be used to produce equivalent results with many other cellular standards, including but not limited to iDEN, IS-95, cmda2000, UTMS and LTE.

The invention comprises
a modified cellular handset (“handset”) and
at least one remote PBX (“PBX”) that has been specially programmed to obfuscate its call routing activities.

The handset is modified so that it will constantly shift its identity parameters, appearing to the service cellular network as any one of a large number of handsets at any given time. These handset identities will be novel to the foreign intelligence service and not associated with any particular user or group of interest.

The long-term identity of a GSM cellular handset has three components:
1. The International Subscriber Mobile Identity (IMSI), a 14-15-digit number that is globally unique to the subscriber. The IMSI is held in the Subscriber Identity Mobile (SIM) and is readily accessible by the phone and the network.
2. The International Mobile Equipment Identity (IMEI), a 15-digit number that is supposed to be globally unique to the handset. The IMEI is programmed into the handset during manufacturing, but can be altered with special programming techniques.
3. The subscriber key “Ki”, a 128-bit random number unique to the subscriber and programmed into the SIM. The value of Ki is not directly accessible, but a hypothesized value can be verified through a challenge-response dialog. Several parties have published “attacks” whereby Ki can be computed given a large enough set of challenge-response dialogs.

The handset extracts IMSI and Ki values from a plurality of SIMs and stores these values internally. (The IMSI values can be read directly and the Ki values can be extracted using a known attack on the SIM.) For each stored IMSI, the handset also generates a semi-random IMEI that mimics the IMEI of some widely used model of handset. Given a plurality of {IMSI,IMEI,Ki} tuples, the handset can choose from any of the plurality of plausible electronic identities, each associated with a different telephone number and subscriber account. Prior to use, the handset is programmed with several such identity tuples, drawn from SIMs that are purchased anonymously and not traceable to the user. Once in use, the handset's active identity can be changed regularly according to a clock, according to calling activity or according to any other algorithm than can be known or communicated to the remote PBXs. Ideally, no identity will be used for more than one telephone call, although practical limitations may require identities to be recycled during long missions.

In the first embodiment, the PBX is implemented as a voice-over-internet (VoIP) system comprising
an existing VoIP software PBX or switch such as Asterisk, FreeSWITCH or Yate and
a database describing the associations between inbound dialed number and the outbound numbers to which the calls will be forwarded.

The PBX is assigned a large collection of direct inbound dialed (DID) telephone numbers at which it can receive calls and which it can use to provide CLID and ANI information for outbound calls. The pool of telephone numbers is large enough that the numbers are reused infrequently, if ever. Calls to the DID numbers are then relayed to their true destinations by the PBX following the methods shown in FIG. 2, FIG. 4 and FIG. 6, based on association information stored in a database inside the PBX. The system can use multiple PBXs, in multiple locations, connected to the PSTN through multiple services to prevent their detection or identification. These multiple PBXs use identical databases to track number-user associations, with these databases kept synchronized using standard techniques known in the field of database design.

It is critical for the proper operation of the system that these PBXs not be placed in legal jurisdictions that are likely to cooperate with the operators of the hostile PLMN. It is critical for the proper operation of the system that these PBXs not use PSTN origination/termination services in legal jurisdictions that are likely to cooperate with the operators of the hostile PLMN. It is recommended that each PBX use multiple PSTN origination/termination services so that the inbound and outbound segments of a forwarded call be connected to the PSTN in different countries.

### Second Embodiment

In a second embodiment, the handset takes its IMSI and Ki value directly from a standard subscriber identity module (SIM), preferably a SIM issued by a carrier that operates or has significant number of roaming subscribers the area where the handset is to be used and obtained from an untraceable source. The handset is modified to automatically generate a new semi-random IMEI value whenever the SIM is changed. (By “semi-random” we mean that the IMEI value is chosen to match a known model of cellular handset, but is otherwise random.) When the new SIM is first installed into the handset, the user calls one of a pool of designated telephone numbers at a remote PBX and identifies himself or herself through a spoken passphrase or series of key-presses. Once the user is identified to the PBX as using a particular SIM with a particular, known telephone number, the PBX can use this information to route inbound calls as shown in FIG. 1 and FIG. 2. Outbound dialing is the same as in the first embodiment and FIG. 3, FIG. 4, FIG. 5 and FIG. 6.

### Enhancements

The security of the invention can be enhanced by automatically limited the number of telephone calls that might be made or received with a given SIM or given telephone number. Limits on outbound calls are most safely enforced by a modification to the handset so that the call attempt can be blocked before there has been any interaction with a potentially hostile network. Limits on inbound calls are best implemented in the remote PBX so that the call attempt can be blocked before there has been any interaction with a potentially hostile network.

### Benefits of the Invention

In many countries, telephone carriers, including cellular telephone carriers, operate in close cooperation with government intelligence services. These intelligence services can use call routing data (records of who is calling whom) determine patterns of communication among a group, and identify members of a given group who might not otherwise be detected. These intelligence services can also use cellular telephone mobility data (records of which tower is serving a handset at a given time) to track the movements of individuals from one neighborhood or city to another. Calling patterns and identify information are also used as triggers to invoke call interception; if a call is not associated with an individual or group of interest, it is unlikely to be subject to interception.

For some visitors to foreign countries, such as diplomats, journalists, aid workers or US government employees working under cover, the exposure of calling patterns and location information to a foreign intelligence service creates an immediate danger, both for the visitor and for that visitor's contacts within the country. The invention protects the identity, privacy and safety of its user and his or her associates.

### Other Embodiments

Although this invention has been described with respect to preferred embodiments (GSM cellular, for example), it should be understood that many variations and modifications will now be obvious to those skilled in the art, and it is preferred, therefore, that the scope of the invention be limited, not by the specific disclosure herein, but only by the appended claims.

### CROSS REFERENCE TO DISCLOSURE DOCUMENT

This application is based upon Disclosure Document “Utility Patent Application (Provisional) Mechanism for Anonymous Calls to and from Cellular Telephones” filed 10 May 2010.

The embodiments of the invention in which we claim an exclusive property or privilege are defined as follows:

1. A system for preventing the operator of a cellular network from identifying the parties to a cellular telephone call, comprising: a private branch exchange (PBX) that forwards inbound telephone calls according to a set of known rules and one (or more) cellular handset capable of changing its (their) identity parameters.

2. A system for preventing the operator of a cellular network from identifying the parties to a cellular telephone call, comprising: a multiple private branch exchange (PBXs) that all forward inbound telephone calls according to a common set of known rules, a common database that encodes these call forwarding rules, accessed by the PBXs, and one (or more) cellular handset capable of changing its (their) identity parameters.

3. A system for preventing the operator of a cellular network from identifying the parties to a cellular telephone call, comprising: a multiple private branch exchange (PBXs) that all forward inbound telephone calls according to a set of known rules encoded in a local database, a database synchronization mechanism that keeps encoded rules in all of the local databases identical, and one (or more) cellular handset capable of changing its (their) identity parameters.

4. A cellular telephone handset that automatically generates a new international mobile equipment identity (IMEI) whenever that handset's subscriber identity module (SIM) is changed.

5. A cellular telephone handset that automatically generates a new international mobile equipment identity (IMEI) whenever that handset is turned on after being powered off.

6. A cellular telephone handset that automatically a new international mobile equipment identity (IMEI) whenever the commanded to do so be the user through the entry of a special code on the handset keypad.

7. A cellular telephone handset that generates a new international mobile equipment identity (IMEI) whenever the commanded to do so be the user through the selection of a a contact entry from the handset's electronic contact list where that contact entry is formed according to some predetermined pattern.
